(19) United States
(12) Patent Application Publication
(10) Pub. No.: US 2007/0207751 A1
(43) Pub. Date: Sep. 6, 2007

(54) Radio receiver with shared low noise amplifier for multi-standard operation in a single antenna system

(75) Inventors: Arya Behzad, Poway, CA (US); Prasanna Desai, Olivenhain, CA (US); Brima Ibrahim, Aliso Viejo, CA (US); Mark Gonikberg, Los Altos Hills, CA (US); Thomas Varghese, Bangalore, IN (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 11/711,719

(22) Filed: Feb. 28, 2007

Related U.S. Application Data
(60) Provisional application No. 60/778,421, filed on Mar. 3, 2006.

(51) Int. Cl. H04B 7/08

(52) U.S. Cl. 455/132

(57) ABSTRACT

A radio receiver is described that processes multiple wireless standards using a single antenna according to embodiments of the invention. The radio receiver includes a single antenna, and a low noise amplifier that is connected to the antenna, without an intervening power divider or power splitter. The output of the low noise amplifier feeds multiple wireless receivers in a parallel arrangement that are operating according to different communications standards, including for example a Bluetooth receiver, and a WLAN 802.11 receiver. Additional wireless standards and their corresponding receivers could be added as well. The input impedance of the low noise amplifier defines the impedance seen by the antenna, regardless of which operational standard is actually in use. Since the input impedance of the low noise amplifier is substantially independent of whether the Bluetooth or WLAN paths are ON or OFF, simultaneous operation can be accomplished.

### CROSS REFERENCED TO RELATED APPLICATIONS

This application claims the benefit of U.S. Provisional Application No. 60/778,421, filed on Mar. 3, 2006, which is incorporated by reference herein in its entirety.

### BACKGROUND OF THE INVENTION

1. Field of the Invention

The present invention generally relates to a radio receiver system with a shared low noise amplifier in a multi-standard operation.

2. Background Art

Numerous wireless standards are available today for wireless networks and devices. These multiple standards can often operate in the same frequency bandwidth, but have different applications and uses. For example, both WLAN and Bluetooth operate in the same relative frequency space defined by the IEEE ISM band. Accordingly, a single receiver front-end can be used to support multiple radio standards. For example, both Bluetooth and WLAN (IEEE 802.11) can be processed using a common analog receiver front-end because their frequencies of operation are sufficiently close. In a conventional receiver system, it is desirable to use a single antenna to support multiple radio standards to reduce part count and overall size.

FIG. 1 illustrates a conventional receiver system 100 that supports two radio standards, namely WLAN 802.11 and Bluetooth, using a single antenna. The conventional system 100 includes a single antenna 102, a power splitter 104, and two low noise amplifiers (LNA) 106 and 108. The power splitter 104 is used after the antenna 102 to provide the received signal to each one of the LNAs 106 and 108 for processing according to each standards, while maintaining the proper 50 ohm terminations on all ports. This results in a significant amount of signal power loss as seen by each one of the LNAs, even if no signal is being received for one of the standards. The signal power loss occurs because the power divider outputs are 3 dB lower than the input power. For example, in a system that is required to operate for both Bluetooth and WLAN in a single antenna configuration, a minimum of a 3 dB power penalty (and therefore noise figure [NF] penalty) occurs regardless of which standard is selected to receive the input signal.

Therefore, what is needed is receiver front-end apparatus that includes a single antenna that can also serve multiple standards without the above mentioned limitations.

### BRIEF SUMMARY

In one embodiment, a radio receiver is configured to process multiple wireless standards using a single antenna. The radio receiver includes a single antenna, and a low noise amplifier is connected to the antenna, without an intervening power divider or power splitter. The output of the low noise amplifier feeds multiple wireless receivers in a parallel arrangement that are operating according to different communications standards, including for example a Bluetooth receiver and a WLAN 802.11 receiver. Additional wireless standards and their corresponding receivers could be added as well. The input impedance of the low noise amplifier defines the impedance seen by the antenna, regardless of which operational standard is actually in use. Since the input impedance of the low noise amplifier is substantially independent of whether the Bluetooth or WLAN paths are ON or OFF, simultaneous operation can be accomplished.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates a conventional radio receiver configured for multi-standard operation using a single antenna and power divider.

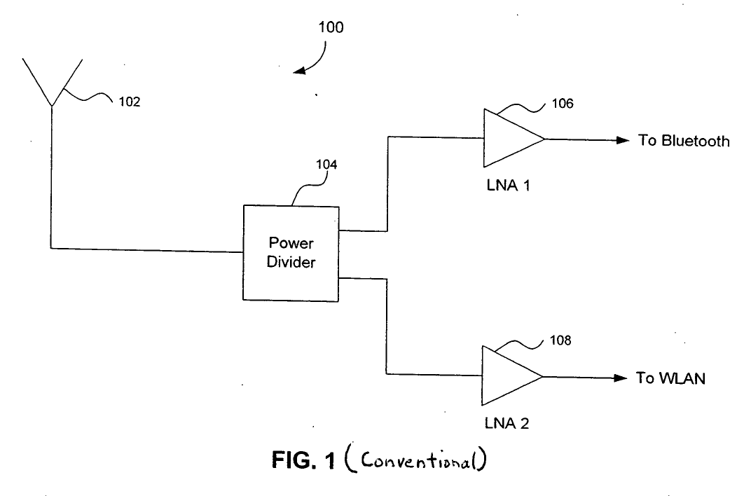

FIG. 2 further illustrates a radio receiver configured for multi-standard operation using a single antenna that does not include a power divider according to embodiments of the present invention.

FIG. 3 further illustrates a radio receiver configured for multi-standard operation using a single antenna and a pre-processing module, but does not include a power divider according to embodiments of the present invention.

### DETAILED DESCRIPTION OF THE INVENTION

A receiver configuration includes a shared properly terminated LNA that is hooked up to the antenna (or other necessary RF components) without an intervening power splitter. The amplified input signal is then split between two signal paths after the first LNA and on chip, where there is no need to maintain 50 ohm terminations. No physical power splitter is used. The gain is slightly reduced because of the additional loading on the 1^{st} LNA, but it can be made to be insignificant.

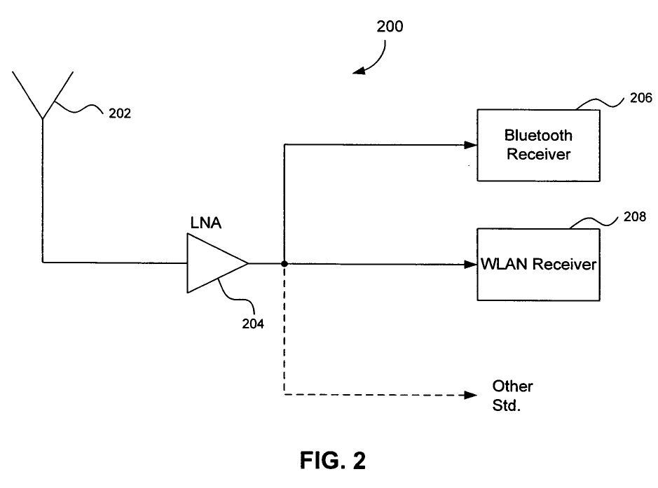

FIG. 2 illustrates a radio receiver 200 configured to process multiple wireless standards using a single antenna according to embodiments of the invention. Receiver 200 includes a single antenna 202, and a low noise amplifier 204. The low noise amplifier 204 is connected directly to the antenna 202, without an intervening power divider or power splitter. The output of the low noise amplifier feeds both a Bluetooth receiver 206, and a WLAN 802.11 receiver 208, in a parallel arrangement as shown. An additional wireless standard could be added as well. In other words, embodiments of the invention are not limited to serving only two standards.

During operation, the antenna 202 receives an input signal that is amplified by the LNA 204 to produce an amplified input signal that is fed to both the Bluetooth receiver 206, and to the WLAN receiver 208. The input impedance of the amplifier 204 defines the impedance seen by the antenna 202 regardless of which operational standard is actually in use. Since the input impedance of the LNA 204 is for the most-part independent of whether the Bluetooth or WLAN paths are ON or OFF, simultaneous operation can be accomplished. Alternatively, each one of the two paths can be completely powered off (while LNA 204 is operating) to save power with minimal impact to the impedance match as seen by the outside world. In other words, since the LNA 204 defines the impedance seen by the antenna 202, one or both of the Bluetooth receiver or the WLAN receiver can be powered off, without effecting the input impedance seem by the antenna significantly.

Further, without the use of a power divider, there is no 3-dB power loss at the output of the LNA 204. In other words, if one of the Bluetooth receiver 206, or WLAN receiver 208 is turned off, then approximately all of the LNA output power will be transferred to the operating receiver (taking into account any mismatch loss). In other words since the split of the signal is performed after the first LNA, the impact on the system noise figure has been minimized.

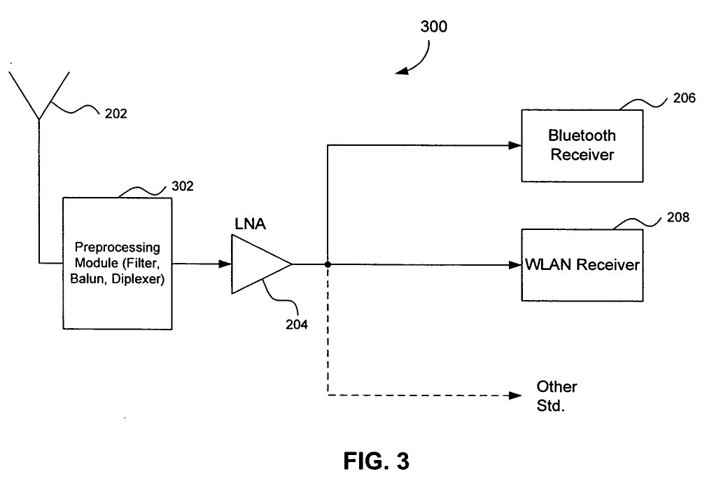

FIG. 3 illustrates a second embodiment of the invention having a radio receiver 300, where a pre-processing module 302 is coupled between the antenna 202 and the input of the low noise amplifier 204. The pre-processing module 302 can any one of a filter (e.g. lowpass or bandpass filter), a diplexer, or a balun, or another type of receiver preprocessing circuit. The pre-processing module 302 is generally configured to have a sufficient bandwidth so as to pass necessary frequencies to support the communications standards for the receivers 206-208, or any other standard meant for use in the radio receiver 300.

The radio receiver 300 operates similar to the radio receiver 200 except that the input impedance of the pre-processing module is preferably matched to the antenna, taking into the consideration impedance of the LNA 204 when powered on.

### CONCLUSION

Example embodiments of the methods, systems, and components of the present invention have been described herein. As noted elsewhere, these example embodiments have been described for illustrative purposes only, and are not limiting. Other embodiments are possible and are covered by the invention. Such other embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

What is claimed is:

1. A radio receiver, comprising:
an antenna;
a low noise amplifier connected to an output of said antenna;
a first circuit corresponding to a first wireless standard coupled to an output of said low noise amplifier; and
a second circuit corresponding to a second wireless standard coupled to an output of said low noise amplifier.

2. The radio receiver of claim 1, wherein said first wireless standard is Bluetooth, and said second wireless standard is WLAN IEEE 802.11.

3. The radio receiver of claim 1, wherein an input impedance of said low noise amplifier is matched to an output impedance of said antenna.

4. The radio receiver of claim 1, wherein said first circuit and said second circuit are directly connected to said output of said low noise amplifier without an intervening power divider.

5. The radio receiver of claim 1, wherein said first circuit is a Bluetooth radio receiver, and said second circuit is a WLAN 802.11 radio receiver.

6. The radio receiver of claim 1, further comprising a third circuit corresponding to a third standard coupled to an output of said low noise amplifier.

7. The radio receiver of claim 1, wherein said second circuit is powered off when an input signal corresponding to said first wireless standard is received by said radio receiver.

8. The radio receiver of claim 1, wherein said first circuit is powered off when an input signal corresponding to said second wireless standard is received by said radio receiver.

9. The radio receiver of claim 1, wherein said first and second circuits are powered off, when neither said first wireless standard or said second wireless standard is operational.

10. The radio receiver of claim 9, wherein said low noise amplifier maintains an impedance match to said antenna even when at least one of said first and second circuits are powered off.

11. A radio receiver, comprising:
an antenna;
a pre-processing module coupled to an output of said antenna;
a low noise amplifier connected to an output of said pre-processing module;
a first circuit corresponding to a first wireless standard coupled to an output of said low noise amplifier; and
a second circuit corresponding to a second wireless standard coupled to an output of said low noise amplifier.

12. The radio receiver of claim 11, wherein said pre-processing module is one of the following: a filter, a diplexer, a switch and a balun.

13. The radio receiver of claim 11, wherein said first wireless standard is Bluetooth, and said second wireless standard is WLAN IEEE 802.11.

14. The radio receiver of claim 11, wherein an input impedance of said pre-processing module is matched to an output impedance of said antenna.

15. The radio receiver of claim 11, wherein said first circuit is a Bluetooth radio receiver, and said second circuit is a WLAN 802.11 radio receiver.

16. The radio receiver of claim 11, further comprising a third circuit corresponding to a third standard coupled to an output of said low noise amplifier.

17. The radio receiver of claim 11, wherein said second circuit is powered off when an input signal corresponding to said first wireless standard is received by said radio receiver.

18. The radio receiver of claim 11, wherein said first circuit is powered off when an input signal corresponding to said second wireless standard is received by said radio receiver.

19. The radio receiver of claim 11, wherein said first and second circuits are powered off, and said low noise amplifier is powered on, when neither said first wireless standard or said second wireless standard is operational.

20. The radio receiver of claim 11, wherein said pre-processing module maintains an impedance match to said antenna even when at least one of said first and second circuits are powered off.
